(19) United States
(12) Patent Application Publication
(10) Pub. No.: US 2018/0060896 A1
(43) Pub. Date: Mar. 1, 2018

(54) COLLATERALIZED REWARDS

(71) Applicant: NCR Corporation, Duluth, GA (US)

(72) Inventors: Sean Paul Loosli, Mountain View, CA (US); Suzan Szollar, Menlo Park, CA (US)

(21) Appl. No.: 15/251,765

(22) Filed: Aug. 30, 2016

(51) Int. Cl. G06Q 30/02; G06Q 20/10

(52) U.S. Cl. CPC G06Q 30/0215; G06Q 20/102

(57) ABSTRACT

Various embodiments herein each include at least one of systems, methods, software, and modules for collateralization of reward or loyalty program liability. Some such embodiments provide mechanisms for identifying program liability that has a low likelihood of being redeemed, such as liability associated with participant accounts that have had no activity, and are therefore considered stale accounts, for a certain period, such as two or more years. Liability associated with such accounts may then be bundled into a pool and the entity operating the program may pay another entity to incur the liability for those accounts, typically for pennies on the dollar of financial value of the rewards involved.

### BACKGROUND INFORMATION

Customers have been building value under reward and loyalty programs for many years, going back to at least S&H Green Stamps in 1896. Modern reward and loyalty programs generally provide participants with an account and value is added to the account in the form of mile or points in return for performing a point-gaining activity. Point-gaining activities may be purchases, completing travel segments, completing surveys, purchases of certain products, and the like. These points or miles may or may not expire. While the points or miles themselves may not be measured in financial terms for the customer, the entity operating the program do incur liability for the expense of rewards provided at times of redemption. The liability for outstanding reward or loyalty program awards can become substantial. Such liability may reach a point of having to be included on financial statements of the operating entity. Further, depending on the entity-type, the entity, such as a bank, may be required by law or regulation to maintain cash on-hand for all or a portion of the outstanding liability even for program liability that has a very low likelihood of being redeemed.

### SUMMARY

Various embodiments herein each include at least one of systems, methods, software, and modules for collateralization of reward or loyalty program liability. Some such embodiments provide mechanisms for identifying program liability that has a low likelihood of being redeemed, such as liability associated with participant accounts that have had no activity, and are therefore considered stale accounts, for a certain period, such as two or more years. Liability associated with such accounts may then be bundled into a pool and the entity operating the program may pay another entity to incur the liability for those accounts, typically for pennies on the dollar of financial value of the rewards involved.

For example, one embodiment, in the form of a method, includes identifying an aggregate value of reward program liability from a plurality of reward program accounts and bundling the identified aggregate value of reward program liability into a logical pool defined in stored data with a pool identifier and in association with reward program liability records. This method further includes updating data of a logical pool to identify a party responsible for payment of reward program liability.

Another method embodiment includes storing account data of a plurality of accounts in an account database, the account data of at least some accounts including non-monetary value associated therewith and a date of last activity with regard to the account. The non-monetary value in such embodiments is convertible by formula into a monetary value. This method further includes identifying an aggregate value of non-monetary value associated with a plurality of accounts and bundling the identified aggregate value of non-monetary value into a logical pool defined in stored data with a pool identifier and in association with respective accounts. The logical pool in such embodiments typically has a face monetary value calculated by the non-monetary value conversion formula to the monetary value. This method further updates data of the logical pool to identify a party responsible for payment of reward program liability.

A further embodiment, in the form of a system, includes a database storing account data of a plurality of accounts. The account data of at least some accounts in such embodiments includes non-monetary value associated therewith and a date of last activity with regard to the account, the non-monetary value convertible by formula into a monetary value. This system further includes at least one processor and at least one memory device storing instructions executable by the at least one processor to perform data processing activities. The data processing activities may include identifying an aggregate value of non-monetary value associated with a plurality of accounts and bundling the identified aggregate value of non-monetary value into a logical pool. The logical pool will be defined in stored data with a pool identifier and in association with respective accounts and have a face monetary value calculated by the non-monetary value conversion formula to the monetary value. The data processing activities may further include updating data of a logical pool to identify a party responsible for payment of reward program liability.

### BRIEF DESCRIPTION OF THE DRAWINGS

FIG. 1 is a logical block diagram of system, according to an example embodiment.

FIG. 2 is a block diagram of a computing device, according to an example embodiment.

FIG. 3 is a block flow diagram of method, according to an example embodiment.

FIG. 4 is a block flow diagram of method, according to an example embodiment.

### DETAILED DESCRIPTION

Rewards and loyalty programs allow users to accrue points, miles, or other unit of measure for a variety of activities in connection with a business, a network of businesses, or the like. Several studies have estimated that tens of billions of dollars' worth of loyalty points are granted each year, with a large portion of these points going unclaimed. For financial institutions and other granting institutions, these reward points can represent a liability that they may not want to continue to carry indefinitely. Some of these institutions are also required to have cash on hand to pay out reward obligations to be compliant with laws and regulations. This cash obligation can be a burden for a small financial institution. Just as with loans, where financial institutions have to have a large pool of money on hand to be able to lend it, if they have a large cash obligation outstanding, they may not be able or allowed to continue to generate rewards until they are relieved of that obligation.

Various embodiments herein each include at least one of systems, methods, software, and modules for collateralization of reward or loyalty program liability. Some such embodiments provide mechanisms for identifying program liability that has a low likelihood of being redeemed, such as liability associated with participant accounts that have had no activity, and are therefore considered stale accounts, for a certain period, such as two or more years. Liability associated with such accounts may then be bundled into a pool and the entity operating the program may pay another entity to incur the liability for those accounts, typically for pennies on the dollar of financial value of the rewards involved.

For example, some embodiments provide solutions including systems, software, and modules to create financial instruments of aggregations of these points into a pool and a marketplace to resell an aggregated pool to another entity with the appetite and resources to manage payout. In some embodiments, only the liability is sold as the selling institution may continue to service the account to which the points have been granted. However, the acquiring institution generally doesn't pay for the aggregated pool, but instead is paid to take over the potential liability. The payment is typically at a discount from a face value based on a point-to-currency conversion rate and a percentage of the points of the pool that are likely to be redeemed.

More specifically, financial institutions and other granting entities may sell the obligation for paying out points or other reward redemption to third party entities, where the third party assumes the obligation in exchange for a fee that the seller financial institutions pay the third party for either the lifetime of the obligation or an agreed upon amount of time. A large national financial institution, as the buyer, often can afford to take on this “debt” in exchange for the revenue it would derive from the fees paid by the smaller financial institutions, who would benefit from the debt relief.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” Merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

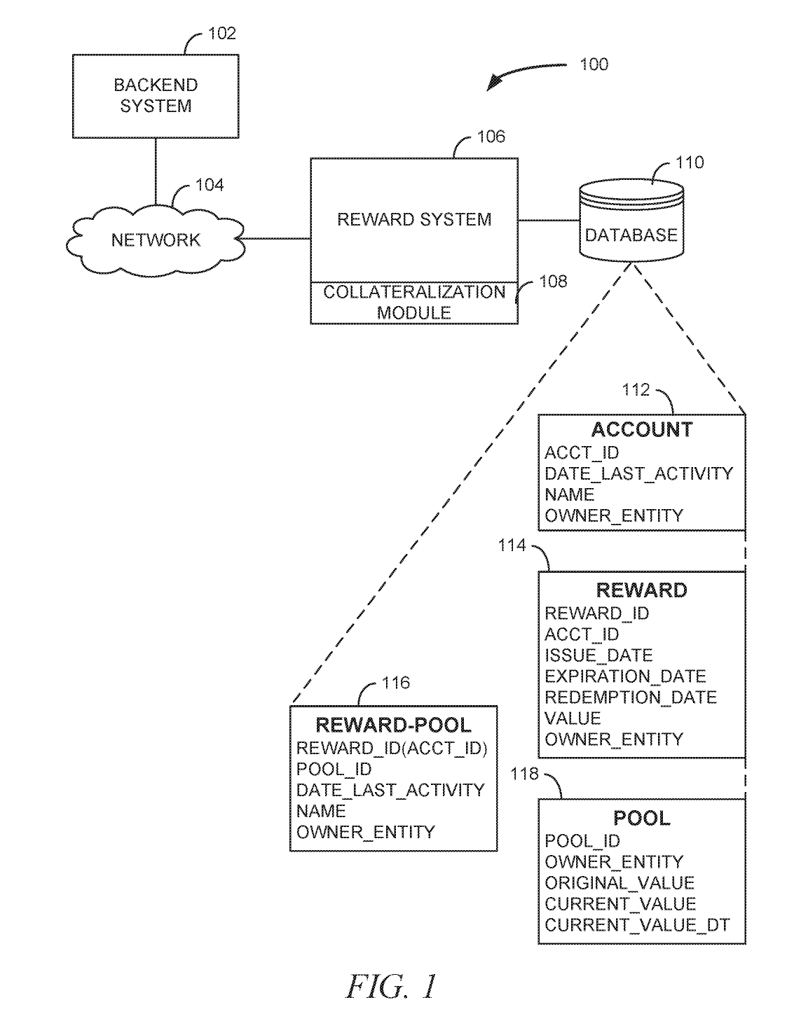

FIG. 1 is a logical block diagram of system 100, according to an example embodiment. The system 100 is an example system on which some embodiments may be implemented. Further, the system 100 includes various elements that are included as examples for how some embodiments may be implemented. As there are different ways and different system, database, and other structural architectures that may be utilized to achieve similar results, the system 100 is provided as an example and deviations therefrom are expected and contemplated herein. The system 100 is therefore but one example embodiment and other embodiments will be readily apparent to a person having ordinary skill in the art.

The system 100 includes a backend system 102 or other system that processes transaction data from which reward points or miles are credited. The backend system 102 may be a banking system, a credit card or other bank card transaction processing system, an airline system that that tracks passenger flights taken, a retail system involved in processing purchase transactions, and the like. Data may be published by the backend system 102 over the network 104 to a reward system 106 or a process of the reward system 106 may retrieve data from the backend system 102 over the network 104. Regardless of how the reward system 106 receives or obtains the backend system 102 data, the reward system 106 processes that data to credit points to user accounts stored in a database 110.

The database 110 stores data of accounts, rewards, aggregated pools of rewards, and pools in tables. Aggregation of the rewards may be made and pools generated by a collateralization module 108, a process of the reward system 106, or other process. The aggregation may occur by the collateralization module 108 querying reward and account records stored in a reward table 114 that are associated with accounts stored in an account table 112 to identify accounts with rewards that are most likely abandoned or have other properties indicating the rewards are not likely to be redeemed. This may include considering a date of last activity with regard to account records in the account table 112. The collateralization module 108 may continue to process the data until either all records have been processed or a certain value threshold for generating a pool has been reached. A pool may then be aggregated by bundling the identified reward and account records into a pool.

The bundling of account and reward records, in some embodiments, includes generating a pool record in a pool table 118 stored in the database 110. reward-pool records are then generated in a reward-pool table 116 that associates the reward records to be bundled into the pool with the pool record generated in the pool table 118.

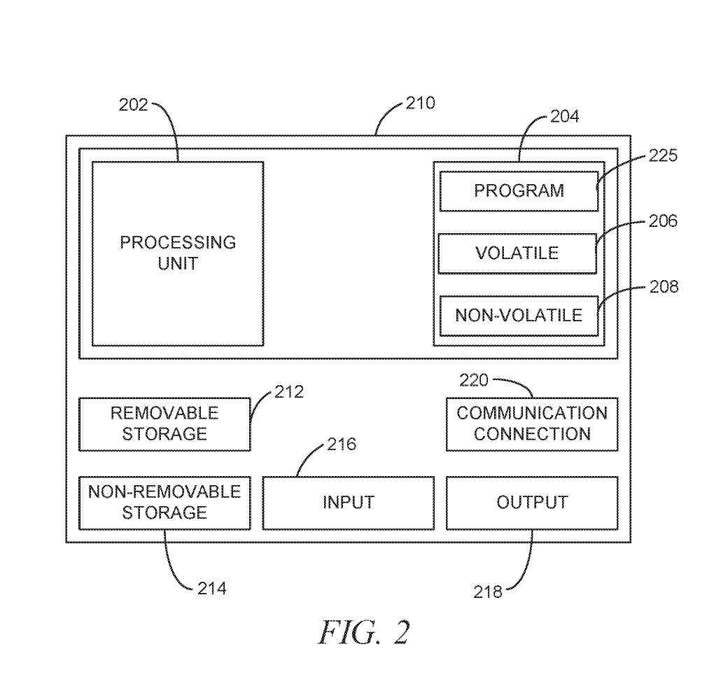

FIG. 2 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 210, may include a processing unit 202, memory 204, removable storage 212, and non-removable storage 214. Although the example computing device is illustrated and described as computer 210, the computing device may be in different forms in different embodiments. For example, the computing device may instead be a smartphone, a tablet, smartwatch, or other computing device including the same or similar elements as illustrated and described with regard to FIG. 2. Devices such as smartphones, tablets, and smartwatches are generally collectively referred to as mobile devices. Further, although the various data storage elements are illustrated as part of the computer 210, the storage may also or alternatively include cloud-based storage accessible via a network, such as the Internet.

Returning to the computer 210, memory 204 may include volatile memory 206 and non-volatile memory 208. Computer 210 may include—or have access to a computing environment that includes a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 210 may include or have access to a computing environment that includes input 216, output 218, and a communication connection 220. The input 216 may include one or more of a touchscreen, touchpad, mouse, keyboard, camera, one or more device-specific buttons, one or more sensors integrated within or coupled via wired or wireless data connections to the computer 210, and other input devices. The computer 210 may operate in a networked environment using a communication connection 220 to connect to one or more remote computers, such as database servers, web servers, and other computing device. An example remote computer may include a personal computer (PC), server, router, network PC, a peer device or other common network node, or the like. The communication connection 220 may be a network interface device such as one or both of an Ethernet card and a wireless card or circuit that may be connected to a network. The network may include one or more of a Local Area Network (LAN), a Wide Area. Network (WAN), the Internet, and other networks. In some embodiments, the communication connection 220 may also or alternatively include a transceiver device, such as a BLUETOOTH® device that enables the computer 210 to wirelessly receive data from and transmit data to other BLUETOOTH® devices.

Computer-readable instructions stored on a computer-readable medium are executable by the processing unit 202 of the computer 210. A hard drive (magnetic disk or solid state), CD-ROM, and RAM are some examples of articles including a non-transitory computer-readable medium. For example, various computer programs 225 or apps, such as one or more applications and modules implementing one or more of the methods illustrated and described herein or an app or application that executes on a mobile device or is accessible via a web browser, may be stored on a non-transitory computer-readable medium.

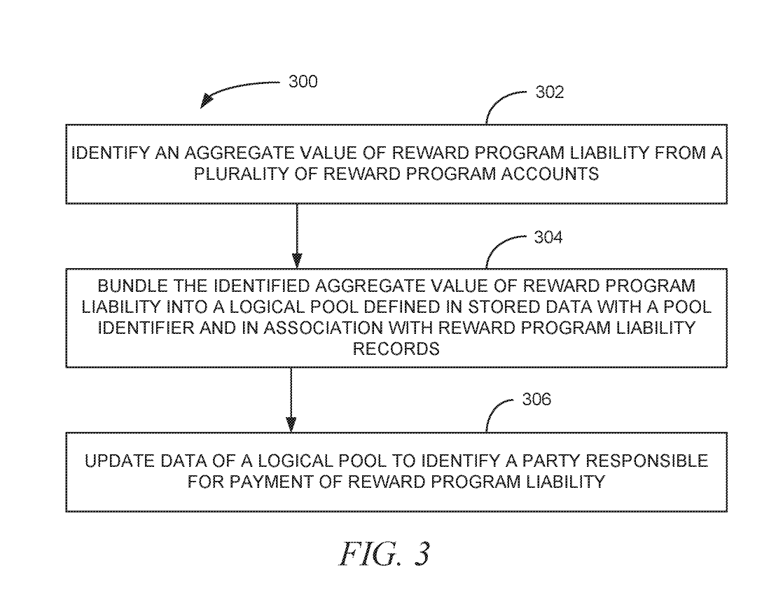

FIG. 3 is a block flow diagram of method 300, according to an example embodiment. The method 300 is an example of a method that may be performed by the collateralization module 108 of FIG. 1.

The method 300 includes identifying 302 an aggregate value of reward program liability from a plurality of reward program accounts and bundling 304 the identified aggregate value of reward program liability into a logical pool defined in stored data with a pool identifier and in association with reward program liability records. The method 300 further includes updating 306 data of a logical pool to identify a party responsible for payment of reward program liability.

In some embodiments of the method 300, the reward program liability is identified 302 based on a plurality of factors including a date with regard to at least one of an expiration of the reward program liability, when the reward program liability was incurred, and a determined likelihood that the reward program liability will be redeemed. In some such embodiments, identifying 302 of the aggregate value of reward program liability includes applying at least one reward program liability identification rule against at least one of reward program liability records and reward program accounts to which reward program liability records are associated. In some additional embodiments, each of the at least one reward program liability identification rules may include at least one factor, satisfaction of which when applied against the at least one of reward program liability records or reward program accounts identifies the at least one reward program liability record or reward program account for the bundling 304 into the logical pool. One such factor may consider whether a period of a particular duration has elapsed since reward program liability has been incurred.

In some other embodiments, the method 300 includes applying a pricing rule against the logical pool to set either an exact price or a price range that a party having original reward program liability is willing to pay another entity to take responsibility for reward liability of the logical pool. Such a pricing rule may include a pricing factor applied against the aggregate value of reward program liability to obtain either the exact price or the price range.

In another embodiment of the method 300, identifying 302 the aggregate value may be performed on a periodic basis. The periodic basis may be scheduled in some such embodiments and automatically triggered. In other embodiments, the aggregate value is threshold amount, satisfaction of which triggers execution of the bundling 304 to form the logical pool. The threshold amount may be an amount of reward program liability to be bundled and an amount reward program liability that is unlikely to be redeemed is monitored. When that monitored amount reached the threshold amount in such embodiments, the bundling 304 may be automatically triggered for execution.

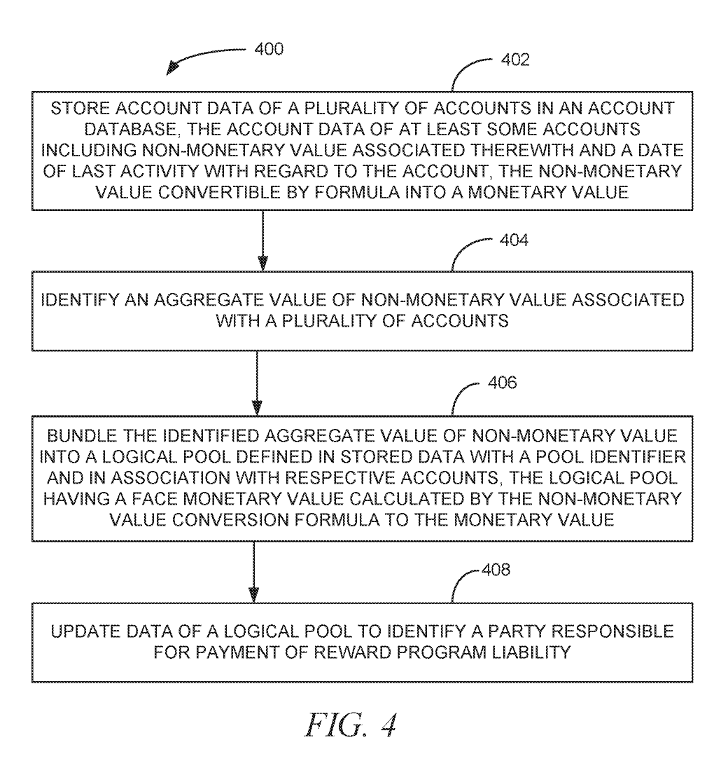

FIG. 4 is a block flow diagram of method 400, according to an example embodiment. The method 400 is another example of a method that may be performed by the collateralization module 108 of FIG. 1.

The method 400 includes storing 402 account data of a plurality of accounts in an account database. The account data of at least some accounts may include non-monetary value associated therewith and a date of last activity with regard to the account. The non-monetary value in such embodiments is generally convertible by formula into a monetary value. The method 400 further identifies 404 an aggregate value of non-monetary value associated with a plurality of accounts and bundles 406 the identified aggregate value of non-monetary value into a logical pool. The logical pools are defined in stored data with a pool identifier and in association with respective accounts. Such a logical pool may have a face monetary value calculated by the non-monetary value conversion formula to the monetary value. The method 400 further includes updating 408 data of a logical pool to identify a party responsible for payment of reward program liability. That party is typically a party that purchases the pool.

In some embodiments of the method 400, the identifying 404 of the aggregate value of non-monetary value includes applying at least one identification rule against account data. Each of the at least one identification rules may include a factor, satisfaction of which when applied against the account data identifies accounts for the bundling into the logical pool.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
identifying an aggregate value of reward program liability from a plurality of reward program accounts;
bundling the identified aggregate value of reward program liability into a logical pool defined in stored data with a pool identifier and in association with reward program liability records; and
updating data of a logical pool to identify a party responsible for payment of reward program liability.

2. The method of claim 1, wherein the reward program liability is identified based on a plurality of factors including a date with regard to at least one of an expiration of the reward program liability, when the reward program liability was incurred, and a determined likelihood that the reward program liability will be redeemed.

3. The method of claim 1, wherein the identifying of the aggregate value of reward program liability includes applying at least one reward program liability identification rule against at least one of reward program liability records and reward program accounts to which reward program liability records are associated.

4. The method of claim 3, wherein each of the at least one reward program liability identification rules include at least one factor, satisfaction of which when applied against the at least one of reward program liability records or reward program accounts identifies the at least one reward program liability record or reward program account for the bundling into the logical pool.

5. The method of claim 4, wherein one factor considers whether a period of a particular duration has elapsed since reward program liability has been incurred.

6. The method of claim 1, further comprising:
applying a pricing rule against the logical pool to set either an exact price or a price range that a party having original reward program liability is willing to pay another entity to take responsibility for reward liability of the logical pool.

7. The method of claim 6, wherein the pricing rule includes a pricing factor applied against the aggregate value of reward program liability to obtain either the exact price or the price range.

8. The method of claim 1, wherein the identifying of the aggregate value is performed on a periodic basis.

9. The method of claim 1, wherein the aggregate value is threshold amount, satisfaction of which triggers execution of the bundling to form the logical pool.

10. A method comprising:
storing account data of a plurality of accounts in an account database, the account data of at least some accounts including non-monetary value associated therewith and a date of last activity with regard to the account, the non-monetary value convertible by formula into a monetary value;
identifying an aggregate value of non-monetary value associated with a plurality of accounts;
bundling the identified aggregate value of non-monetary value into a logical pool defined in stored data with a pool identifier and in association with respective accounts, the logical pool having a face monetary value calculated by the non-monetary value conversion formula to the monetary value; and
updating data of a logical pool to identify a party responsible for payment of reward program liability.

11. The method of claim 10, wherein:
the identifying of the aggregate value of non-monetary value includes applying at least one identification rule against account data; and
each of the at least one identification rules include at least one factor, satisfaction of which when applied against the account data identifies accounts for the bundling into the logical pool.

12. The method of claim 11, wherein one factor considers whether a period of a particular duration has elapsed since the date of last activity with regard to a respective account.

13. The method of claim 10, wherein the aggregate value of non-monetary value is identified based on a plurality of factors including a date with regard to at least one of an expiration of the aggregate value of non-monetary value, when the aggregate value of non-monetary value was incurred, and a determined likelihood that the aggregate value of non-monetary value will be redeemed.

14. The method of claim 10, further comprising:
applying a pricing rule against the logical pool to set either an exact price or a price range that a party having original non-monetary value liability is willing to pay another entity to take responsibility for liability of the logical pool.

15. The method of claim 14, wherein the pricing rule includes a pricing factor applied against the face monetary value of non-monetary value liability to obtain either the exact price or the price range.

16. The method of claim 10, wherein the identifying of the aggregate value is performed on a periodic basis.

17. The method of claim 10, wherein the aggregate value is threshold amount, satisfaction of which triggers execution of the bundling to form the logical pool.

18. A system comprising:
a database storing account data of a plurality of accounts, the account data of at least some accounts including non-monetary value associated therewith and a date of last activity with regard to the account, the non-monetary value convertible by formula into a monetary value;
at least one processor; and
at least one memory device storing instructions executable by the at least one processor to perform data processing activities comprising:
identifying an aggregate value of non-monetary value associated with a plurality of accounts;
bundling the identified aggregate value of non-monetary value into a logical pool defined in stored data with a pool identifier and in association with respective accounts, the logical pool having a face monetary value calculated by the non-monetary value conversion formula to the monetary value; and
updating data of a logical pool to identify a party responsible far payment of regard program liability.

19. The system of claim 18, wherein the aggregate value of non-monetary value is identified based on a plurality of factors including a date with regard to at least one of an expiration of the aggregate value of non-monetary value, when the aggregate value of non-monetary value was incurred, and a determined likelihood that the aggregate value of non-monetary value will be redeemed.

20. The system of claim 18, the data processing activities further comprising:
applying a pricing rule against the logical pool to set either an exact price or a price range that a party having original non-monetary value liability is willing to pay another entity to take responsibility for liability of the logical pool.
